(19) United States
(12) Patent Application Publication
(10) Pub. No.: US 2014/0149501 A1
(43) Pub. Date: May 29, 2014

(54) Efficient Navigation Through Social Networking Content

(71) Applicants: Wayne Kao, Mountain View, CA (US); Ken Deeter, San Francisco, CA (US)

(72) Inventors: Wayne Kao, Mountain View, CA (US); Ken Deeter, San Francisco, CA (US)

(21) Appl. No.: 13/686,752

(22) Filed: Nov. 27, 2012

(51) Int. Cl. H04L 29/06

(52) U.S. Cl. CPC H04L 65/40
USPC 709/204

(57) ABSTRACT

A social networking system presents an interface to a user for easily navigating through content items. The interface includes a content region and a navigation region. The content region displays content items while the navigation region displays navigation units. Each navigation unit represents one or more content items of the content region and is displayed at a location in the navigation region based on a time associated with a content item represented by the navigation unit and based on a value of a metric. Selecting a navigation unit modifies the content region to display the one or more content items associated with the selected navigation unit.

### BACKGROUND

Embodiments of the present disclosure relate generally to social networking systems and, more specifically, to navigating through content items of a social networking system.

Social networking systems have become prevalent in recent years because they allow their users to easily connect to and communicate with other users. Through social networking systems, users share a variety of content items. Examples of content items include pictures, videos, and status updates. This ability to easily share content has caused social networking systems to have significant numbers of users. Because of this popularity, a large number of content items shared via a social networking system are shared each day. Therefore, a social networking system user may often navigate through a significant number of uninteresting content items before identifying relevant or interesting content items.

### SUMMARY

To better allow navigation through presented content items, a social networking system presents a user interface including a content region and a navigation region to a user viewing content items (a “viewing user”). The content region includes content items, such as stories in a news feed or content associated with a user profile. The navigation region includes multiple navigation units, which each represent one or more content items maintained by the social networking system.

The navigation region represents a specific time interval, such as a week or a month, and presents a navigation unit at a location within the navigation region based on a time associated with the content item represented by the navigation unit. Additionally, presentation of the navigation unit within the navigation region is based on metric information about the one or more content items represented by the navigation unit. Various types of metric information may be displayed by the navigation region. Examples of metric information include: a number of interactions between users and one or more content items associated with the navigation unit, an affinity between the viewing user and a user associated with a content item associated with the navigation unit, and an amount of activity with one or more content items associated with the navigation unit. In one embodiment, the navigation region represents the time interval along a horizontal axis and represents the metric information along a vertical axis.

Based on the metric information associated with navigation units displayed in the navigation region, the viewing user may select a navigation unit. One or more content items represented by the selected navigation region are then retrieved and presented in the content region. For example, when a navigation unit is selected, the social networking system modifies a position of a news feed displayed in the content region to display stories identifying content items represented by the selected navigation unit. Hence, accessing a navigation unit allows a viewing user to easily identify and access content items maintained by the social networking system.

### BRIEF DESCRIPTION OF THE DRAWINGS

FIGS. 1A-1E are illustrations of an example user interface for interacting with content items presented by a social networking system, in accordance with an embodiment of the invention.

FIG. 2 is a block diagram of a system environment for a social networking system, in accordance with an embodiment of the invention.

FIG. 3 is a block diagram of a system architecture of a social networking system, in accordance with an embodiment of the invention.

FIG. 4 is a flow chart of a process for navigating multiple content items maintained by a social networking system, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

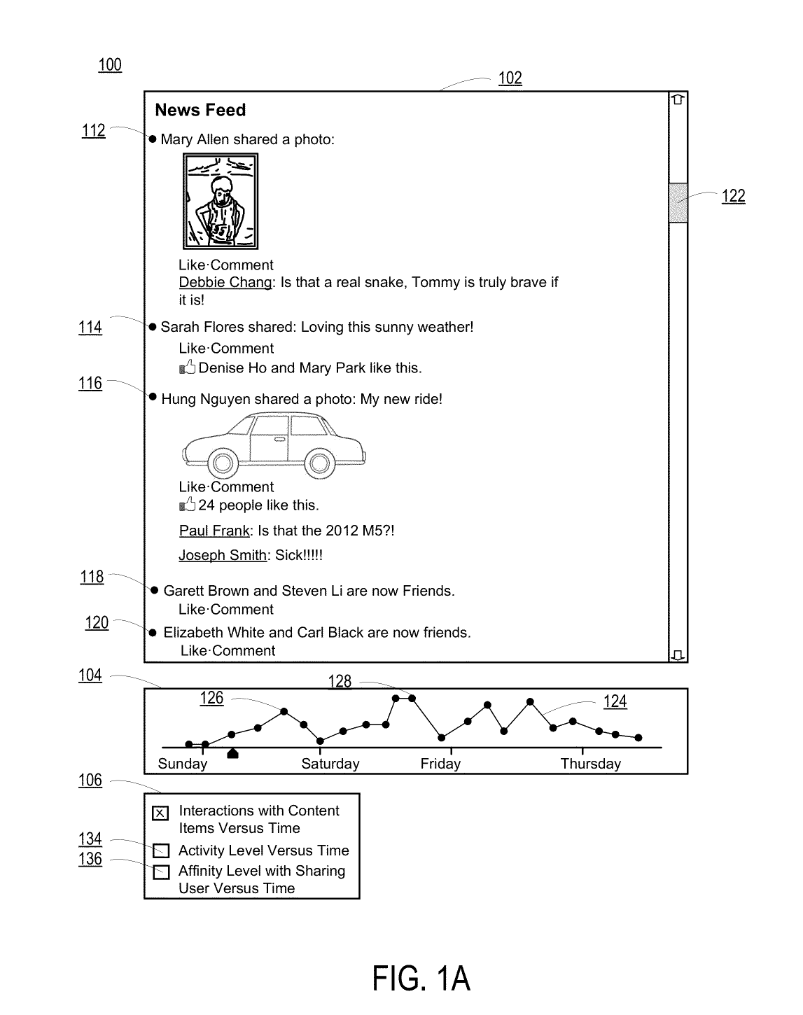

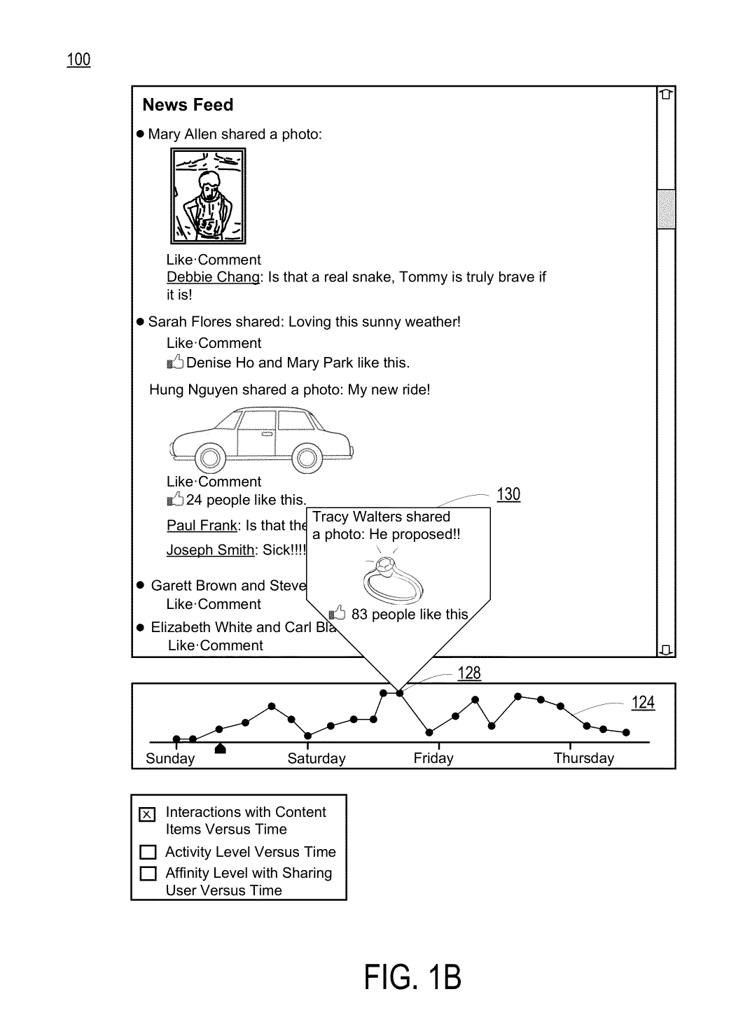

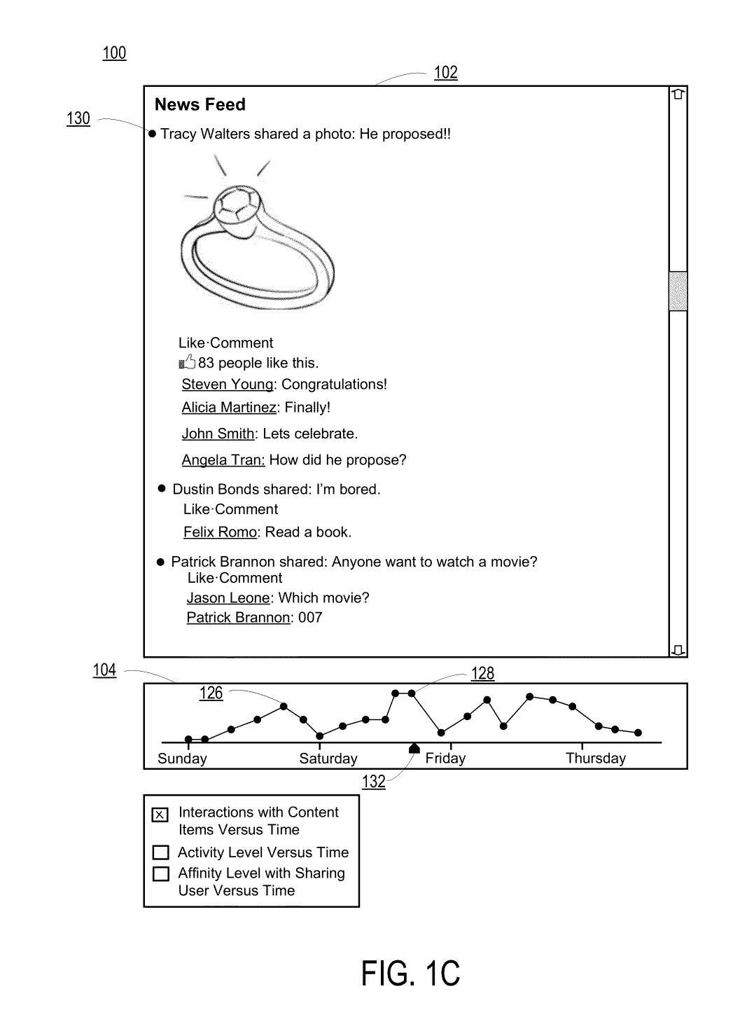

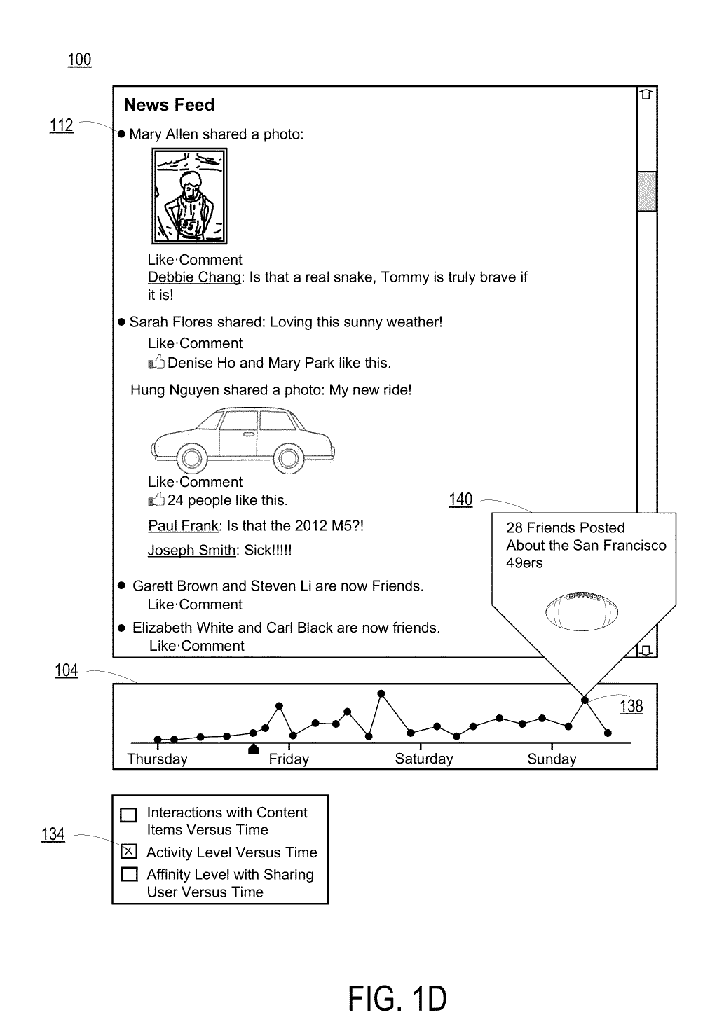

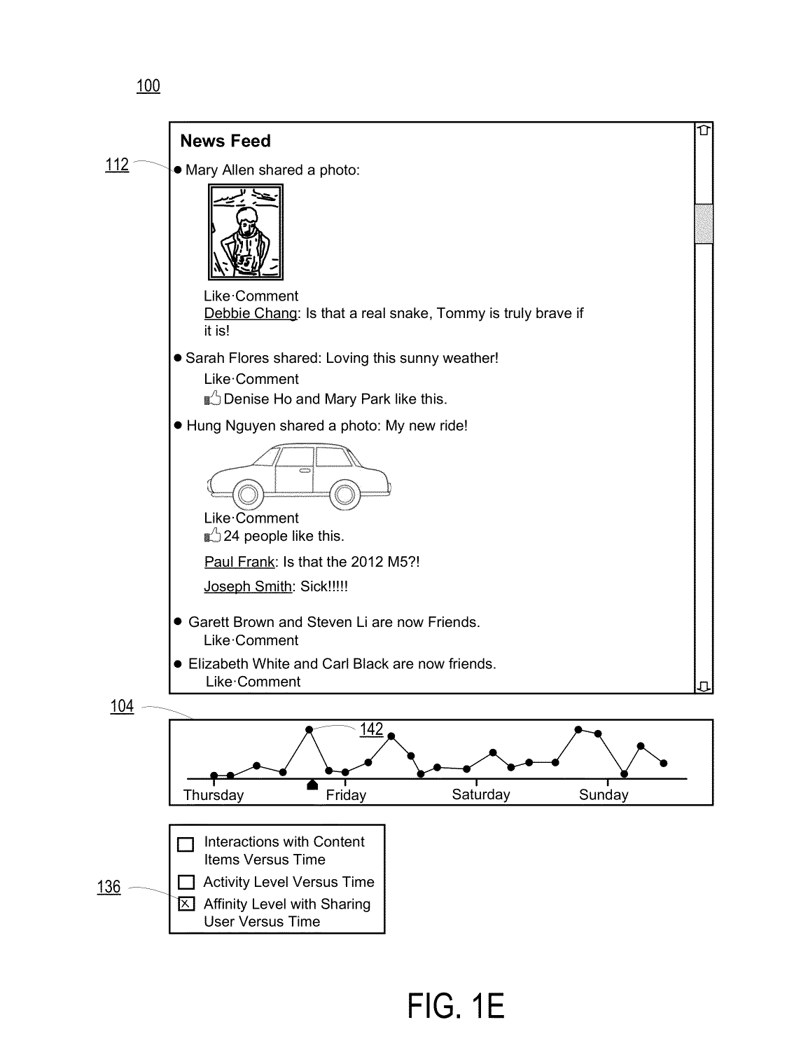

FIGS. 1A-1E show examples of a user interface 100 for navigating through content items provided by a social networking system. Content items represent individual portions of content presented by a social networking system to its users. The social networking system may obtain the content items from various sources, such as receiving a content item from a user or inferring a content item from actions taken by one or more social networking system users. Examples of content items include: photos, videos, status updates, articles, geographic locations of users, events, establishment of a connection between users, and changes to a user's profile (e.g., change in relationship status).

The user interface 100 includes a content region 102, a navigation region 104, and a control region 106. The content region 102 includes one or more content items 112, 114, 116, 118, 120 selected by a social networking system for presentation to the user. In the examples of FIG. 1A-1E the content items 112, 114, 116, 118, 120 are arranged in a news feed in chronological order from top to bottom. However, in other embodiments, the content items 112, 114, 116, 118, 120 may be presented in any suitable manner.

A user may navigate through the content region 102 to view additional content items. For example, the content region 102 includes a scroll bar 122 allowing the user to modify the content items displayed in the content region 102. Additionally, the user may interact with the navigation region 104 to modify the content items presented in the content region 102. In the examples of FIGS. 1A-1E, the navigation region 104 displays multiple navigation units on a graph 124 with a horizontal axis representing a time interval and a vertical axis representing metric information. Each navigation unit represents one or more content items maintained by the social networking system; for example, a navigation unit represents content items previously selected for presentation to the user via the content region 102. For example, navigation unit 126 represents content item 116 from the content region 102.

The horizontal position of a navigation unit within the graph 124 represents a time associated with a content item represented by the navigation unit. For example, the time may be the time when a content item was selected for presentation to the user or may be the time when a content item was generated by the social networking system. The vertical position of a navigation unit within the graph 124 represents a metric of the content items. In the example of FIG. 1A, the metric is the number of user interactions with the content items. Therefore, the position of a navigation unit within the graph 124 indicates a time associated with a content item represented by the navigation unit and a number of interactions with the content item. For example, the position of the navigation unit 128 in the navigation region 104 indicates that a content item with which a large number of users interacted was presented on Friday.

FIG. 1B illustrates that user interactions with a navigation unit may provide information about one or more of the content items represented by the navigation unit. For example, information may be provided if a user performs a specific type of interaction with the navigation unit, such as hovering over the navigation unit for a specified length of time. In the example of FIG. 1B, hovering over navigation unit 128 causes the display of an information unit 130 including the content item represented by navigation unit 128. As shown in FIG. 3B, additional information describing interactions with the content item, such as the number of users expressing a preference for the content item (“liking” the content item) is also displayed by the information unit 130.

Additionally, interacting with a navigation unit allows a user to modify the content presented in the content region 102. For example, selecting a navigation unit causes one or more content items represented by the selected navigation unit to be presented. In the example of FIG. 1C, selecting navigation unit 128 causes presentation of content item 130, which is represented by navigation unit 128, in the content region 102. A scroll unit 132 may be displayed in the navigation region 104 identifying the temporal location of the content item 130 in the content region 102 relative to content items represented by other navigation units in the navigation region 104. In one embodiment, the user may reposition the scroll unit 132 along the horizontal axis of the navigation region 104, causing the content region 102 to display content items associated with times within an interval of a time indicated by the position of the scroll unit 132 along the horizontal axis of the navigation region 104. For example, if a user moves the scroll unit 132 along the horizontal axis toward navigation unit 126, content items displayed in the content region 102 are modified based on the changing time information until the scroll unit 132 reaches navigation unit 126, when the content item represented by navigation unit 126 is presented in the content region 102.

Returning to FIG. 1A, the control region 106 allows a user to modify the metric information displayed by the navigation region 104. In the examples of FIGS. 1A-1C, the vertical axis of the navigation region 104 illustrates the amount of user interactions with content items represented by navigation units. The control region 106 presents options for modifying the type of metric information displayed by the navigation region 104. For example, selecting option 134 updates the navigation region 104 to display the activity of social networking users with the social networking system. Hence, rather than display interactions with the content items represented by navigation units, the navigation region 104 displays an overall number of user interactions with the social networking system at various times within the time interval shown by the navigation region 104. FIG. 1D illustrates the navigation region 104 updated to display user interactions with the social networking system.

In the example of FIG. 1D, each navigation unit represents multiple content items selected for presentation to the user during a time interval, which may be specified by the user or determined by the social networking system. Performing a type of interaction, such as hovering over, with navigation unit 138 displays an information unit 140 describing the content items represented by navigation unit 138. For example as in FIG. 1D, the information unit 140 may display subject matter associated with at least a threshold number of content items represented by the information, or the information unit 140 may display one or more other characteristics associated with content items represented by the navigation unit 138.

In the example of FIG. 1E, the navigation region 104 shows the affinity between the user to which the interface 100 is presented and users that shared content items over time. For example, option 136 is selected from the control region 106, causing the display of affinity level shown by FIG. 1E. The affinity between two users may be based on a variety of factors. For example, types of connections between the user to which the interface 100 is presented and another user and interactions between the user to which the interface 100 is presented and content items associated with the other user affects the affinity between the user to which the interface 110 is presented and the other user. For example, FIG. 1E shows that the user viewing the interface 100 has a high affinity for a user associated with one or more content items associated with navigation unit 142.

Therefore, the positioning of navigation units in the navigation region 104 provides information about content items which may be displayed in the content region 102. This information allows users to evaluate characteristics of various content items to more easily identify content items of interest. The navigation region 104 also allows users to easily access identified content items of interest.

For example, if a user has not accessed the social networking system in a few days, hundreds of content items may have been provided to the social networking system by users connected to the user. Scrolling through all of the content items is inconvenient and time-consuming for the user. However, based on information presented via the navigation region 104, the user may easily identify content items popular among users (e.g., FIGS. 1A-1C), a time range when most of the content items were provided (e.g., FIG. 1D), and whether users with which the user has a high affinity shared content items (e.g., FIG. 1E). Thus, out of the hundreds of content items, the user may easily identify interesting content items.

### System Architecture

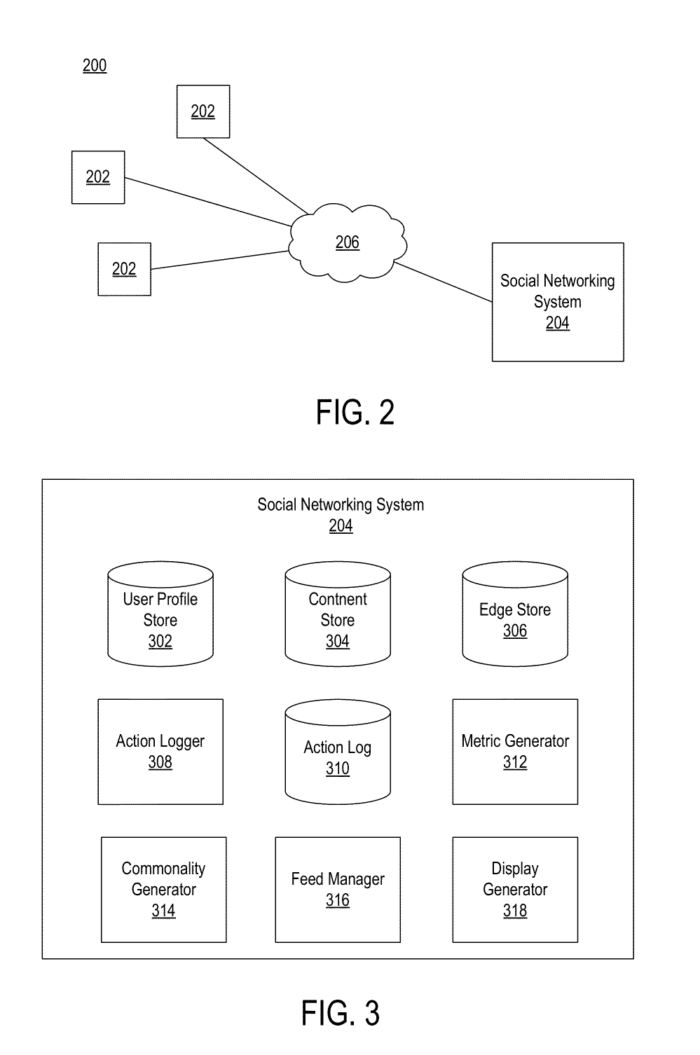

FIG. 2 is a high level block diagram illustrating a system environment 200 for a social networking system 204. The system environment 200 shown in FIG. 2 comprises one or more client devices 202 and the social networking system 204 communicating via a network 206. In alternative configurations, different and/or additional components may be included in the system environment 200. The embodiments described herein can be adapted to online systems that are not social networking systems.

A client device 202 is a computing device capable of receiving user input as well as transmitting and/or receiving data via the network 206. In one embodiment, a client device 202 is a conventional computer system, such as a desktop or laptop computer. In another embodiment, a client device 202 may be a device having computer functionality, such as a personal digital assistant (PDA), mobile telephone, smart-phone or similar device. In one embodiment, a client device 202 executes an application allowing a user of the client device 202 to interact with the social networking system 204. For example, a client device 210 executes a browser application to enable interaction between the client device 202 and the social networking system 204 via the network 206. In another embodiment, a client device 202 interacts with the social networking system 204 through an application programming interface (API) that runs on the native operating system of the client device 202, such as IOS® or ANDROID™.

The network 206 may comprise any combination of local region and/or wide region networks, using both wired and wireless communication systems. In one embodiment, the network 206 uses standard communications technologies and/or protocols. Thus, the network 206 may include communication links using technologies such as Ethernet, 802.11, worldwide interoperability for microwave access (WiMAX), 3G, 4G, code division multiple access (CDMA), digital subscriber line (DSL), etc. Similarly, the networking protocols used on the network 206 may include multiprotocol label switching (MPLS), transmission control protocol/Internet protocol (TCP/IP), User Datagram Protocol (UDP), hypertext transport protocol (HTTP), simple mail transfer protocol (SMTP) and file transfer protocol (FTP). Data exchanged over the network 206 may be represented using technologies and/or formats including hypertext markup language (HTML) or extensible markup language (XML). In addition, all or some of the communication links may be encrypted using conventional encryption technologies such as secure sockets layer (SSL), transport layer security (TLS), and Internet Protocol security (IPsec).

FIG. 3 is an example block diagram of a system architecture of the social networking system 204. The social networking system 204 shown in FIG. 2 includes a user profile store 302, a content store 304, an edge store 306, an action logger 308, an action log 310, a metric generator 312, a commonality generator 314, a feed manager 316, and display generator 318. In other embodiments, the social networking system 204 may include additional, fewer, or different modules for various applications. Conventional components such as network interfaces, security functions, load balancers, failover servers, management and network operations consoles, and the like are not shown so as to not obscure the details of the system architecture.

The user profile store 302 stores user profiles of users of the social networking 204. In one embodiment, each user of the social networking system 204 has a user profile, which is stored in the user profile store 302. A user profile includes declarative information about a user that was explicitly shared by the user and may also include profile information inferred by the social networking system 204. Examples of information included in a user profile include: biographic information, demographic information, work experience, relationship status, educational history, gender, hobbies or preferences, location and the like. A user profile may also include content items (e.g., photos, videos, status updates) related to the user, such as content items provided by the user to the social networking system 204 or content items provided by other users that involve the user (e.g., a photo including the user).

The content store 304 stores content items provided by users to the social networking system 204 for sharing with other users. As described above, examples of content items include: photos, videos, status updates, published articles (e.g., news or sports articles), blog entries, geographic locations of users, events, and links to electronic content. The content store may store content items as different objects. Content items stored in the content store 304 may also include content generated by the social networking system 204 based on actions taken by user interactions captured by the social networking system 204. For example, the social networking system 204 generates stories describing actions taken by social networking system users. For example, a story may identify an action performed by a user, the user performing the action, and a user or content item on which the action was performed.

The edge store 306 stores edges describing connections between users and other users or other objects in the social networking system 204. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 204, such as expressing interest in a profile/page of a business user, sharing content items with other users of the social networking system 204, and commenting on content items of other users of the social networking system 204.

In one embodiment, the edge store 306 includes affinity scores in stored edges. An affinity score is a metric that represents the affinity that a user has towards another user object based on the actions performed by the user (e.g., the closeness between two users). An affinity score of an edge may be computed by the social networking system 204 over time to approximate a user's affinity for a particular object or other social networking system user. Computation of the affinity score may be based on the interactions performed by the user and/or number of associations between the user and an object or other user. In one aspect, the more positive interactions a user performs with an object, the greater the affinity score associated with the edge between the object and the user. Computation of affinity is further described in U.S. patent application Ser. No. 12/978,265, filed on Dec. 23, 2010, which is hereby incorporated by reference in its entirety.

The action logger 308 receives communications about user actions, such as interacting with a recommendation unit, internal to and external to the social networking system 204, and populates the action log 310 with information describing user actions. Such actions may include, for example, adding a connection to another user, sending a message to another user, uploading an image, reading a message from another user, viewing content associated with another user, attending an event posted by another user, among others. These actions are stored in the action log 310. Examples of data describing an interaction with a content item stored in the action log 310 include: an identifier of the content item, an identifier of the and user that interacted with the content item, the time of the interaction, the date of the interaction, and how the user accessed the content item (e.g., through a user profile or a feed).

Users may interact with various objects on the social networking system 204, including commenting on posts, sharing links, and checking-in to physical locations via a mobile device, accessing content items in a sequence, or other interactions. Information describing these actions is stored in the action log 310. In addition, a number of actions described in connection with other objects are directed at particular users, so these actions are associated with those users as well. Additional examples of interactions with objects on the social networking system 204 included in the action log 310 include commenting on a photo album, enabling communications between users, becoming a fan of a musician, adding an event to a calendar, joining a group, becoming a fan of a brand page, creating an event, authorizing an application, using an application, and engaging in a transaction. The action log 310 also records a user's interactions with recommendations and advertisements on the social networking system 100 as well as other applications operating on the social networking system 100.

The action log 310 may also store user actions taken on external websites. For example, a fitness application residing on a third-party website that monitors diet, fitness activities, and rest habits may recognize a user of a social networking system 204 through social plug-ins enabling the external website to identify the user of the social networking system 204. Because users of the social networking system 204 are uniquely identifiable, third party websites, such as this fitness website, may use the information about these users as they visit their websites or use their applications. The action log 310 records data about these users, including webpage viewing histories, applications that were used, advertisements that were engaged, purchases made, and other patterns from shopping and buying.

A metric generator 312 generates metrics for content items stored in the content store 304 based on information stored in the action log 310. In one embodiment the metric generator 312 generates one or more of the following metrics: a total number of times users have accessed a content item, total number of comments associated with a content item received from users, and a total number indications of preference for a content item (“likes” of the content item). The metric generator 310 may generate metrics specialized for particular types of content items. For example, a number of users indicating they are attending an event content item may be calculated. Any other suitable metric describing interactions with one or more content items may be generated.

In one embodiment, the metrics generated for a content item may be personalized for a specific user. For example, the metric generator 312 generates metrics describing a total number of interactions with a content item by other users connected to the user or by other users having a specified type of connection to the user. The generated metrics may describe interactions within a particular time period or may describe an overall number of interactions from creation of a content item to a current time.

Additionally, the metric generator 312 may identify a total number of interactions with content items in a time interval based on information in the action log 310. The total number of interactions may have a particular type or may be an aggregate total of various types of interactions. Further, the total number of interactions may be further refined by additional criteria. For example, the total number of interactions within a time interval by users connected to a particular user may be determined.

In one embodiment, the metric generator 312 generates one or more of the metrics based on a request from the display generator 328. The request identifies the type of metric to calculate and may include one or more parameters for generating the metric. Information from the action log 312 is retrieved and used to generate the requested type of metric as described above. In one embodiment, the metric generator 312 updates a generated metric periodically or when an interaction associated with the metric is added to the action log 310.

The commonality generator 314 identifies subject matter common to multiple content items. In one embodiment, the commonality generator 314 identifies the subject matter of content items by analyzing text included in the content items and identifying subject matter included in at least a threshold number of the content items as the subject matter common to the content items. Therefore, to determine the subject matter of a number of content items according to this embodiment, the commonality generator 314 identifies text associated with each of the content items. For example, if a content item is a status update, the commonality generator 314 retrieves the text of the status update from content store 304. If the content item is a picture, the commonality generator 314 may retrieve the text of the picture's caption and the names of users identified (e.g., tagged) in the picture.

The commonality generator 314 may remove certain words from the text of the content items, such as pronouns and profanities. In one embodiment, the commonality generator 314 removes any word that is not a noun. After removal of words, the remaining words are compared, and, if more than a threshold number of content items (e.g., more than half) have a word in common, the common word is identified as subject matter of the content items. For example, if 7 out of 10 pictures include in the caption “Prom Night,” the commonality generator 314 identifies the subject matter of the 7 pictures as “Prom Night.” The identified subject matter may be used to generate an informational message identifying the subject matter of a group of content items.

Alternatively, the commonality generator 314 identifies anchor terms included in content items and determines a meaning of the anchor terms as further described in U.S. application Ser. No. 13/167,701, filed Jun. 24, 2011, which is hereby incorporated by reference in its entirety. If at least a threshold number of content items have the same meaning of the anchor terms, the common meaning of the anchor terms is identified as the subject matter common to the content items. In other embodiments, any suitable method may be used to identify subject matter common to multiple content items.

The feed manager 316 identifies content items to present to a user requesting content. The identified content may be presented using a news feed for the requesting user. A news feed for a requesting user includes multiple stories identifying actions performed by users and may also identify a content item on which the action was performed. The news feed may describe actions performed by users connected to the requesting user. When a request for a news feed is received, the feed manager 316 identifies users connected to the user requesting the news feed from the edge store 306 and identifies interactions with content items performed by the users connected to the requesting user from the action log 310. Content items associated with one or more of the identified interactions may also be retrieved from the content store 304 and used to by the feed manager to generate the stories presented to the user.

In one embodiment, the feed manager 316 identifies interactions with content items or content items based on a time interval, so interactions or content items associated with times included in the time interval are used to generate stories for the news feed. For example, the feed manager 316 may search for content items stored in the content store 304 or for interactions performed since a news feed was last presented to the requesting user. In one embodiment, certain types of interactions or content items are excluded from the search (e.g., content items describing that two users have established a connection). In one embodiment, the feed manager 316 arranges the generated stories in chronological order based on information in the stories, such as when an interaction described in the story was performed. The feed manager 316 provides the generated stories to the display generator 318 for presentation to the requesting user.

The display generator 318 transmits information to a user device 202 to cause presentation of information from the social networking system 204. In one embodiment, the display generator 318 transmits information to the user device 202 to generate a user interface including a content region and a navigation region when a user of the user device 202 requests content from the social networking system 204. Content items from the social networking system 204 are displayed in content region, while navigation units for traversing the content items are displayed in the navigation region. The display generator 318 generates navigation units identifying content items or groups of content items based on time information associated with the content items. Additionally, the display generator 318 may determine the content items presented in the content region based on times and/or dates associated with the content items.

As described above, a navigation unit represents one or more content items presented or previously presented to the user requesting the content. The navigation region presents the navigation units along a time interval, so that a location within the navigation region indicates a time associated with one or more content items represented by a navigation unit. By selecting a navigation unit, a user modifies the content region so that one or more content items represented by the selected navigation unit are displayed.

As described above in conjunction with FIGS. 1A-1E, the navigation region also displays navigation units so that the location of the navigation unit within the navigation region describes a metric describing one or more of the content items represented by the navigation unit. In one embodiment, the metric information shown by the navigation region is selected by the requesting user. Examples of the metric information displayed using the navigation region are further described above in conjunction with FIGS. 1A-1E. A default metric may be selected so that metric information for the default metric is shown in the navigation region unless a user selects an alternative metric. A user may select a metric for display using a control region of an interface, as described above in conjunction with FIGS. 1A-1E. In one embodiment, if the metric determined for a navigation unit is below a threshold, the navigation unit is not included in the navigation region.

The number of navigation units displayed in the navigation region may be modified depending on the metric information shown by the navigation region. For example, if the navigation region displays a number of interactions, the display generator 318 associates a single content item with a navigation unit. Similarly, if the navigation region displays an affinity between a user viewing the navigation region and one or more users associated with a content item, the display generator 318 associates a single content item with a navigation unit. Thus, when these metrics are displayed, the position of a navigation unit in the navigation region indicates the value of the metric associated with a corresponding content item.

However, if the navigation region displays overall activity between users and the social networking system, the display generator 318 creates equal time intervals. In one embodiment, the time interval length is selected by the requesting user. Alternatively, the time interval lengths are determined by equally dividing a specified time duration. Based on times associated with content items, the display generator 328 identifies a time interval including the time associated with a content item and includes the content item in a navigation unit associated with the time interval. The time associated with a content item may be a time of a most recent interaction with the content item or a time when the content item was generated or received by the social networking system 204. Thus, a navigation unit represents multiple content items associated with times within a time interval. For example, if the time intervals are 24 hours and a specified duration is one week, the display generator 328 creates 7 time period. In one embodiment, if a navigation unit represents less than a threshold number of content items, the navigation unit is not displayed in the navigation region

The location of each navigation unit within the navigation region is determined based on a time associated with one or more content items represented by the navigation unit and a metric value associated with the navigation unit. In one embodiment, a first axis of the navigation region represents a time interval and a second axis represents value of a metric. Hence, a time associated with a content item represented by the navigation unit determines the navigation unit's position along the first axis, and a metric value associated with the navigation unit determines the navigation unit's position along the second axis. FIGS. 1A-1E show examples where a horizontal axis of the navigation region represents time and a vertical axis of the navigation region represents metric value. In another embodiment, the location of a navigation unit along an axis of the navigation region is determined based on a position of a content item represented by the navigation unit within a feed or series of content presented to a requesting user. For example, if a content item is the fifth content item in a news feed generated for a requesting user, the navigation unit corresponding to this content item is displayed in the navigation region at a location based on the content item location in the news feed.

The display generator 318 transmits information to the user device 202 identifying the navigation units, their position in the navigation region, and other information for generating the content region and the navigation region. Based on the received information, the user device 202 generates the content region and the navigation region, as well as presents content items and navigation units. In one embodiment, navigation units are connected by lines to generate a line graph in the navigation region. If a line graph is displayed, the navigation units may be hidden until a type of input with the navigation region is received (e.g., an input selection mechanism hovers over a navigation unit for at least a threshold length of time).

As described above in conjunction with FIGS. 1B and 1D, a user may select a navigation unit using a type of input to receive additional information about the navigation unit. For example, if a user hovers an input mechanism over a navigation unit for at least a threshold length of time, the navigation unit is selected and information about the navigation unit is presented. In one embodiment, information about the navigation unit is presented in an information unit, which includes a content item represented by the selected navigation unit or subject matter associated with at least a threshold number of content items represented by the selected navigation unit as well as a metric value associated with the navigation unit. The information unit may also include identifying information (e.g., profile pictures) of one or more users associated with one or more content items represented by selected the navigation unit.

The navigation region may also include a scroll unit movable along an axis of the navigation region. For example, repositioning the scroll unit along an axis of the navigation region representing time modifies the content region to display content items associated with times within a threshold time of a time corresponding to the location of the scroll unit along the axis. Use of a scroll unit is further described above in conjunction with FIG. 1C.

In one embodiment, the navigation region may include two sets of navigation units that identify values of different metrics. For example, a first set of navigation units have positions within the navigation region based on a value of a first metric and times associated with corresponding content items, a second set of navigation units may also be displayed having positions within the navigation region based on a value of a second metric and times associated with corresponding content items. The same content items may be represented by both the first set of navigation units and the second set of navigation units, allowing the navigation region to indicate two different metric values for the same content items. For example, one set of navigation units have positions in the navigation region indicating interactions with the content items, and a second set of navigation units have positions in the navigation region indicating the affinity of a requesting user for users associated with one or more of the content items.

### Process for Content Item Navigation

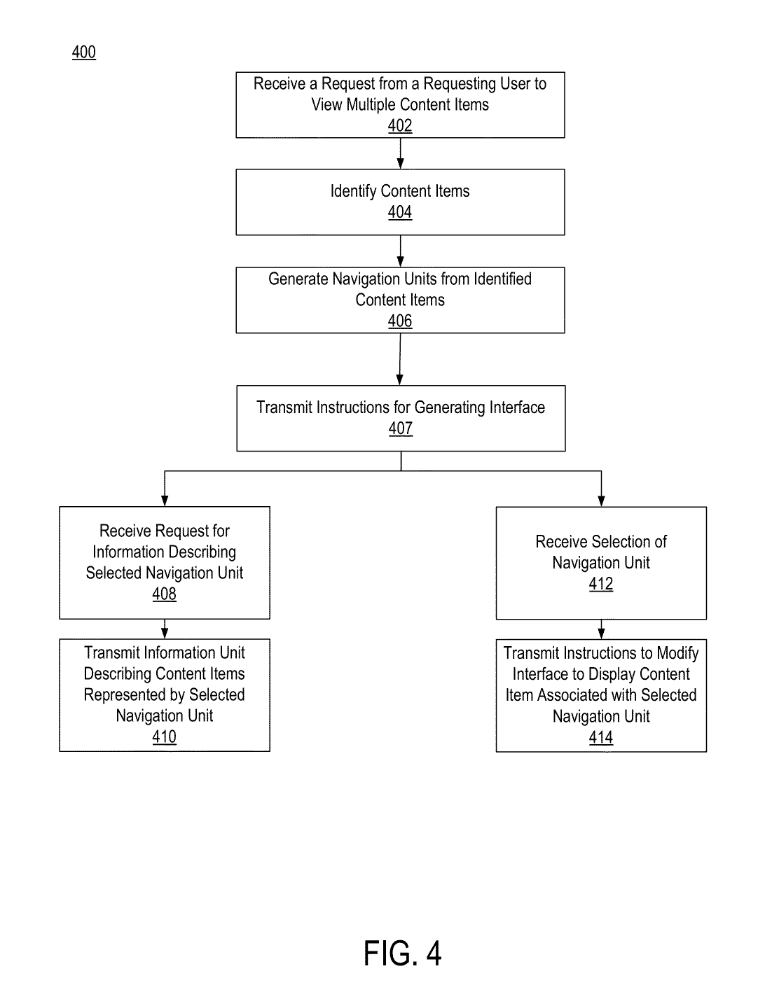

FIG. 4 is a flow chart of one embodiment of a process 400 for presenting multiple content items from a social networking system 204 to a requesting user. The social networking system 204 receives 402 a request from a requesting user for content items. For example, the requesting user may request a news feed including content items describing actions performed by users connected to the requesting user. The social networking system 204 identifies 404 the content items to present to the requesting user, as described above in conjunction with FIG. 3.

Based on the identified content items, the social networking system 204 generates 406 navigation units, each associated with one or more content items. Additionally, a navigation unit is associated with a time determined from the one or more associated content items and a value of a metric determined from the one or more content items. The social networking system 204 transmits 407 instructions for generating an interface to a user device 202 from which the request was received. When executed by the user device 202, the interface includes a content region displaying a subset of the identified content items and a navigation region displaying the navigation units. As described above in conjunction with FIGS. 1 and 3, the navigation units are displayed in the navigation region at positions based on their associated time and metric value.

If a request for information associated with a selected navigation unit is received 408, the social networking system 204 transmits 410 an information unit describing the content items associated with the selected navigation unit and additional information associated with the navigation unit for display by the user device 202. Further details about the content of an information unit are provided above in conjunction with FIGS. 1B, 1D and 3.

If a selection of a navigation unit is received 412, the social networking system 214 transmits 414 instructions to modify the generated interface to present one or more content items associated with the selected navigation unit in the content region. The social networking system 204 may also retrieve and transmit the one or more content items associated with the selected navigation unit to the user device 202 for display in the content region. As described above in conjunction with FIGS. 1A-1E, interactions with the interface to modify the metric associated with the navigation unit may be transmitted to the social networking system 204, which generates a modified metric associated with each navigation unit based on the interactions and transmits the modified metrics to the user device 202 for updating the navigation region.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
transmitting a request for content items for a requesting user to a social networking system;
receiving the content items from the social networking system;
receiving navigation units from the social networking system, each navigation unit associated with at least one identified content item, a time determined from the at least one content item, and a value of a metric generated based on the at least one identified content item;
displaying a subset of the received content items in a content region;
displaying the received navigation units in a navigation region, a position where a navigation unit is displayed in the navigation region determined based on the time associated with the navigation unit and the value of the metric associated with the navigation unit;
receiving a selection of a navigation unit displayed in the navigation region; and
modifying the content region to display a content item associated with the selected navigation unit.

2. The computer-implemented method of claim 1, wherein the position where the navigation unit is displayed in the navigation region is a location along a first axis determined by the time associated with the navigation unit and a location along a second axis determined by the value of the metric associated with the navigation unit.

3. The computer-implemented method of claim 1, wherein the metric associated with a navigation unit is selected from a group consisting of: a number of interactions between users of the social networking system and a content item, an affinity between the requesting user and a user associated with a content item, and a number of interactions between users and the social networking system, and any combination thereof.

4. The computer-implemented method of claim 1, further comprising:
receiving a request for information associated with an identified navigation unit displayed in the navigation region; and
displaying information associated with the at least one content item associated with the identified navigation unit and a value of the metric associated with the identified navigation unit.

5. The computer-implemented method of claim 4, wherein the information associated with the at least one content item associated with the identified navigation unit is selected from a group consisting of: the at least one content item associated with the identified navigation unit, a subject matter of the at least one content item associated with the identified navigation unit, an identifier of one or more users associated with the at least one content item associated with the identified navigation unit, and any combination thereof.

6. The computer-implemented method of claim 1, further comprising:
receiving additional navigation units from the social networking system, each additional navigation unit associated with at least one identified content item, a time determined from the at least one content item, and a value of an alternative metric generated based on the at least one identified content item; and
displaying the received additional navigation units in the navigation region, a position where an additional navigation unit is displayed in the navigation region determined based on a time associated with the additional navigation unit and a value of the alternative metric associated with the navigation unit.

7. A computer-implemented method comprising:
transmitting a request for content items for a requesting user to a social networking system;
receiving the content items from the social networking system;
receiving navigation units from the social networking system, each navigation unit associated with at least one identified content item, a time determined from the at least one content item, and a value of a metric generated based on the at least one identified content item;
displaying a subset of the received content items in a content region; and
displaying the received navigation units in a navigation region, a position where a navigation unit is displayed in the navigation region determined based on the time associated with the navigation unit and the value of the metric associated with the navigation unit.

8. The computer-implemented method of claim 7, wherein the position where the navigation unit is displayed in the navigation region is a location along a first axis determined by the time associated with the navigation unit and a location along a second axis determined by the value of the metric associated with the navigation unit.

9. The computer-implemented method of claim 7, wherein the metric is selected from a group consisting of: a number of interactions between users of the social networking system connected to the requesting user and a content item, an affinity between the requesting user and a user associated with a content item, and an number of interactions between users and the social networking system, and any combination thereof.

10. The computer-implemented method of claim 7, further comprising:
receiving a request for information associated with an identified navigation unit displayed in the navigation region; and
displaying information associated with the at least one content item associated with the identified navigation unit and a value of the metric associated with the identified navigation unit.

11. The computer-implemented method of claim 10, wherein the information associated with the at least one content item associated with the identified navigation unit is selected from a group consisting of: the at least one content item associated with the identified navigation unit, a subject matter of the at least one content item associated with the identified navigation unit, an identifier of one or more users associated with the at least one content item associated with the identified navigation unit, and any combination thereof.

12. The computer-implemented method of claim 7, further comprising:
receiving additional navigation units from the social networking system, each additional navigation unit associated with at least one identified content item, a time determined from the at least one content item, and a value of an alternative metric generated based on the at least one identified content item; and
displaying the received additional navigation units in the navigation region, a position where an additional navigation unit is displayed in the navigation region determined based on a time associated with the additional navigation unit and a value of the alternative metric associated with the navigation unit.

13. A computer-implemented method comprising:
receiving a request for content items from a requesting user;
identifying content items to present to the requesting user;
generating navigation units based on the identified content items, each navigation unit associated with at least one identified content item, a time determined from the at least one content item, and a value of the metric generated based on the at least one identified content item;
transmitting instructions for generating an interface to a user device associated with the requesting user, the instructions for displaying a subset of the identified content items in a content region and displaying the navigation units in a navigation region, where a position a navigation unit is displayed in the navigation region is determined based on a time associated with the navigation unit and a value of the metric associated with the navigation unit.

14. The computer-implemented method of claim 13, further comprising:
receiving a selection of a navigation unit displayed in the navigation region; and
transmitting one or more content items associated with the selected navigation unit displayed in the navigation unit for display in the content region for display by the user device.

15. The computer-implemented method of claim 13, further comprising:
receiving a request for information associated with an identified navigation unit displayed in the navigation region; and
transmitting information associated with the at least one content item associated with the identified navigation unit and a value of the metric associated with the identified navigation unit for display by the user device.
